(19) United States
(12) Patent Application Publication
(10) Pub. No.: US 2013/0159850 A1
(43) Pub. Date: Jun. 20, 2013

(54) ENHANCED RAPID SERIAL VISUAL PRESENTATION SPEED-READING FOR ELECTRONIC READING DEVICES

(71) Applicant: barnesandnoble.com llc, New York, NY (US)

(72) Inventor: Harold Edward COHN, Incline Village, NV (US)

(73) Assignee: barnesandnoble.com llc, New York, NY (US)

(21) Appl. No.: 13/718,941

(22) Filed: Dec. 18, 2012

Related U.S. Application Data
(60) Provisional application No. 61/577,610, filed on Dec. 19, 2011.

(51) Int. Cl. G06F 17/21

(52) U.S. Cl. CPC G06F 17/211
USPC 715/273

(57) ABSTRACT

A system and method for controlling the presentation of words on an electronic reading device to assist in speed reading. A portion of the display screen on the device is reserved for the serial presentation of the words in accordance with the speed reading method. The remainder of the screen contains the current text of the content being read, but is shaded, darkened, so as to not distract the reader. The presentation of words is momentarily paused at sentence and chapter transitions. This momentary pause allows the user to maintain perspective as to the user's location in an electronic text (e.g., a book) and enhances the reading experience and ultimately enhances the speed of the reading exercise and the retention of content.

### FIELD OF THE INVENTION

The present invention generally relates to systems and methods for presenting electronic publications, and more particularly to systems and methods for presenting electronic documents for enhanced speed reading.

### BACKGROUND OF THE INVENTION

The Rapid Serial Visual Presentation, RSVP, speed reading method was developed in the early 1970's and has been well studied. Carnegie Mellon found in controlled situations, 720 words per minute, wpm, can he achieved using the method. For short text, a 33% increase in speed can he achieved without loss of comprehension. Wichita State University found an 82% increase in word comprehension. In its basic form, RSVP presents one or multiple words to the reader in rapid succession. This presentation method prevents the reader's eyes from having to move across the page, thus reducing eye stress and decoupling eye movement and rate of word consumption. There are times when a user wants to consume content more rapidly, for example textbooks or research.

### SUMMARY OF THE INVENTION

The present invention provides several significant improvements to the conventional RSVP systems. In a preferred embodiment, a portion of the display screen on the electronic reader is reserved for the serial presentation of the words in accordance with the RSVP method. The remainder of the screen contains the current text of the content being read, but is shaded, darkened, so as to not distract the reader. In one embodiment of the present invention, the presentation of words is momentarily paused at sentence and chapter transitions. This momentary pause allows the user to maintain perspective as to where she is in an electronic text (e.g., a book) and enhances the reading experience and ultimately enhances the retention of the content.

In a further embodiment of the present invention, the rate at which words are presented is slowed in proportion to the length of the word being presented. If the words are less than a predetermined length, e.g., six characters, the words are presented at a constant predetermined rate (e.g., 200 ms/word). If the length of word is more than six characters, the word is presented for a slightly longer duration to provide the reader sufficient time to process the word. This rate can vary between 25-50% of the standard word rate.

In another embodiment of the present invention, words with an atomic meaning are presented together. For example, the date “Apr. 21, 1994” is presented together, rather than a default approach presenting “April”, “21” then “1994” separately.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates an electronic device of the present invention before the invocation of the speed reading features;

FIGS. 2 and 3 illustrate exemplary embodiments of the present invention on the electronic reader; and

FIG. 4 illustrates the components of an exemplary device.

### DETAILED DESCRIPTION OF THE INVENTION

The present invention considers new technologies, user interfaces and features that can be applied to enhance the user experience. Many readers have wanted to read more rapidly since they began reading, but never found a compelling method. The present invention delivers a technology that can help people consume content more quickly using electronic reading devices. This technology has the benefit of helping readers who need to reduce their time spent reading.

The RSVP method has been in isolated use as a Web Reader and in some electronic devices. However, the reading of electronic publications on electronic devices was not a big phenomenon in the early 2000's, but has finally taken off since 2009 due to the popularity of electronic book readers, eReaders, such as the Nook™ from Barnes & Noble™.

Although the basic components of the present invention are significant in and of themselves, an object of the present invention is to create a more compelling experience and ideally a feature that dramatically improves the reading experience.

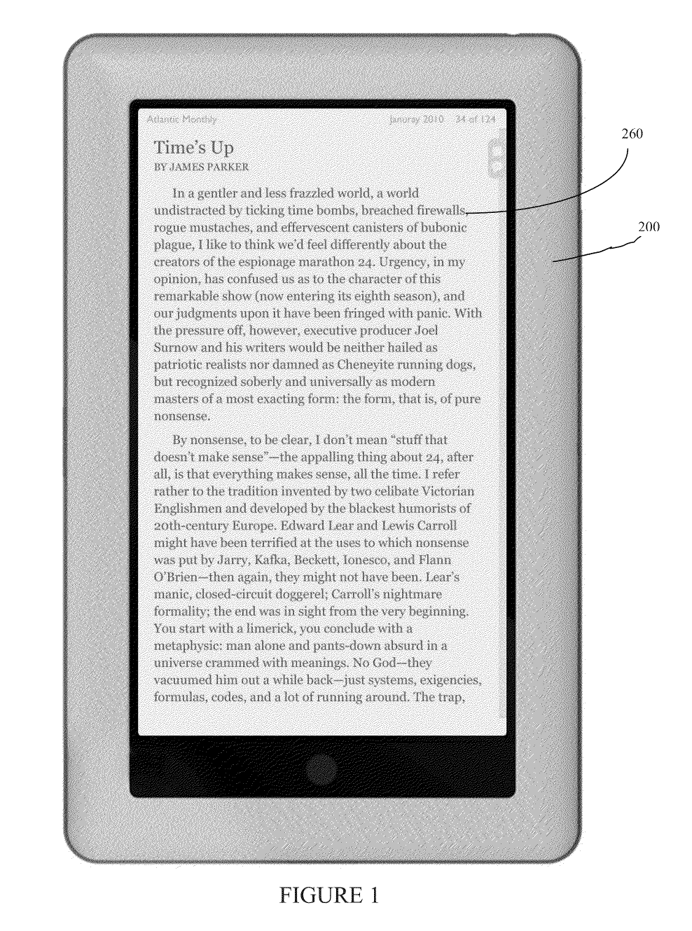

FIG. 1 illustrates an exemplary electronic device 200 of the present invention before the invocation of the speed reading features. As shown in this Figure, a page 260 of an electronic book is being displayed on the device 200 in a traditional manner for presenting an electronic publication.

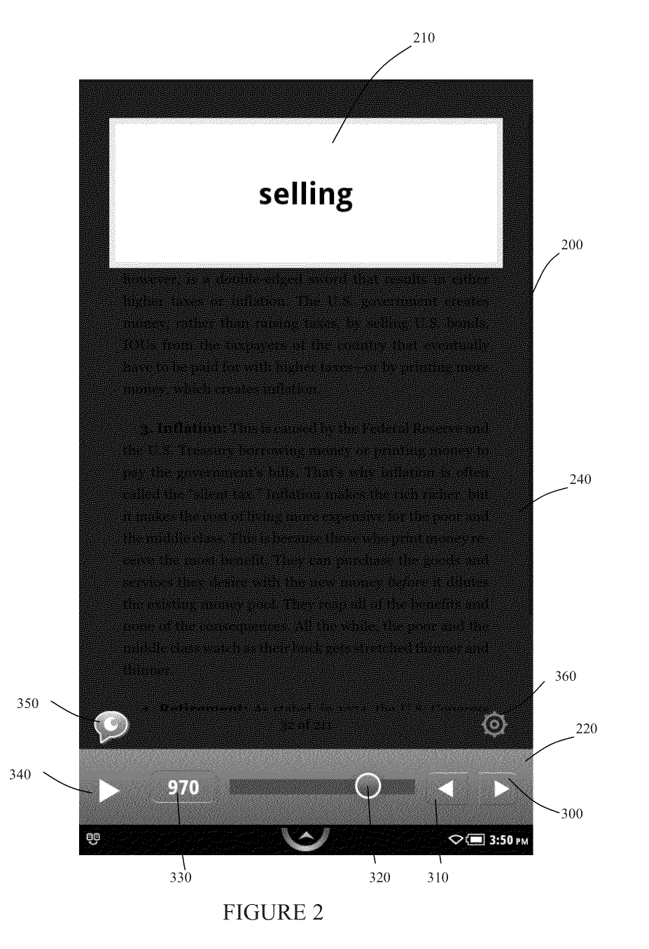

FIG. 2 illustrates an embodiment of the present invention. In accordance with the RSVP method, words are presented to the user on the screen of the electronic reader 200 in area 210 on the display of the device 200. The remainder of the text 240 of the page of the electronic publication being displayed is darkened out. One feature of the present invention is slowing word presentation at paragraph and chapter transitions. The notion of briefly slowing presentation at punctuation marks is conventional and an extremely important way to help readers retain information after completing a sentence. If for example, a reader is reading at 300 wpm, each word is presented for approximately 200 ms. When encountering a comma, a reader pauses for 400 ms (double the normal wpm rate) and 600 ms for periods. However, the conventional methods do not perform similar pauses at paragraph and chapter transitions. The present invention creates pauses of approximately 1 second at paragraph transitions, and approximately 2 seconds at chapter transitions. These pauses generated by the present invention let the reader know that she is making these transitions.

In accordance with a further aspect of the present invention, slower presentation is affected when presenting large words in order to improve the user's comprehension. In a preferred embodiment, the presentation rate is slowed for words larger than six characters. The average English word is 5.4 characters. In the case of larger words, the preferred embodiment slows the wpm rate slightly, by approximately 25-50%. In a further embodiment, the rate could be slowed progressively based on word size. For example, 6 characters or less might have a normal word presentation duration of 200 ms, while encountering words with 8 characters might be slowed to 225 ms, 10 characters to 250 ms, 12 characters to 275 ms, and so on. The timing mentioned herein is exemplary only, and can be increased or decreased as desired.

In accordance with another aspect of the present invention, several words with atomic meaning are grouped together. For example, under conventional RSVP presentation, a date is broken into separate words presented in succession, e.g., “April” then “21” then “1994”. This method of presentation is visually awkward. To improve a reader's comprehension, the present invention groups these short word and number segments to display one concatenation: “Apr. 21, 1994”. This feature can be extended to other example such as titles (“Dr. Frankenstein”), and small articles (e.g., “I like”, “a peanut”, “my toes”, etc.).

In accordance with another aspect of the present invention, transitions are visually marked. Although it is important not to distract the reader when he is reading with RSVP, keeping track of one's progress and location within a book is important to readers. A small visual indicator, e.g. an icon, is displayed to the user, using a smooth fading effect above or below the RSVP area 210 to inform the reader of transitions (sentence, paragraph, chapter, image available, etc.). The duration of display of the indicator is contingent on the type of transition.

For example, a large black or white dot might appear someone near the word presentation area 210 to indicate the end of a sentence. The dot can appear when the final word of the sentence is displayed, then fade quickly, e.g., 0.5 seconds, so the user has a chance to notice the indicator, but have it also disappear as they begin reading into the next sentence. This feature of a smooth fading indicator can also be extended to other transitions. For example, for paragraphs transitions, the a paragraph symbol could be used with other symbols for, chapters, indexes, contents, etc.

The image icon can be displayed that indicates an image can he found on the page the user is reading. For example, the image icon could remain “lit” for as long as the reader is reading on that page. The reader can tap on the image icon to display the image and pause the word playback. Several image icons can be displayed if there are several images on the page the user is reading. The image icons could also he thumbnails of the original images. In another embodiment (e.g., by user option), the images could simply be displayed below the word presentation box 210 since there is so much room available on the display, making the display of an image icon or thumbnail unnecessary. The user can continue the resume the word presentation mode by simply tapping the display or a play button

A significant aspect of the present invention is allowing the reader to maintain context within the electronic publication. Readers find it important to maintain their context while speed-reading. The user knowing where she is in a sentence, paragraph or page while speed reading, is a significant problem with the RSVP technique. The present invention enables a user to maintain context, when using an electronic reader in an RSVP mode. When the user stops or pauses the RSVP mode, the invention displays the standard book text 240 normally (undarkened, as illustrated in FIG. 1) with the current RSVP word frozen at the top of the screen 210 with the word highlighted in the text 240 below. The user can navigate using existing methods, e.g., page turns, and then resume speed-reading at a different point in the electronic publication. That point can be the first word on the page or can be selected by the user, e.g., tapping on the word. The user can also select a word or sentence from which to begin reading in the RSVP mode.

In a further aspect of this feature of the present invention, the current word in word presentation area 210 could be animated to move to the highlighted word in the traditional page display during a toggle between the speed reading mode and regular reading mode. The opposite effect could occur when continuing the speed reading mode, enlarging and moving the text from the traditional page display to the presentation box 210.

In a further embodiment, the system can display the current page, number of pages, chapter number and title above or below the word presentation window 210. This allows the user to maintain context within the electronic publication that she is reading.

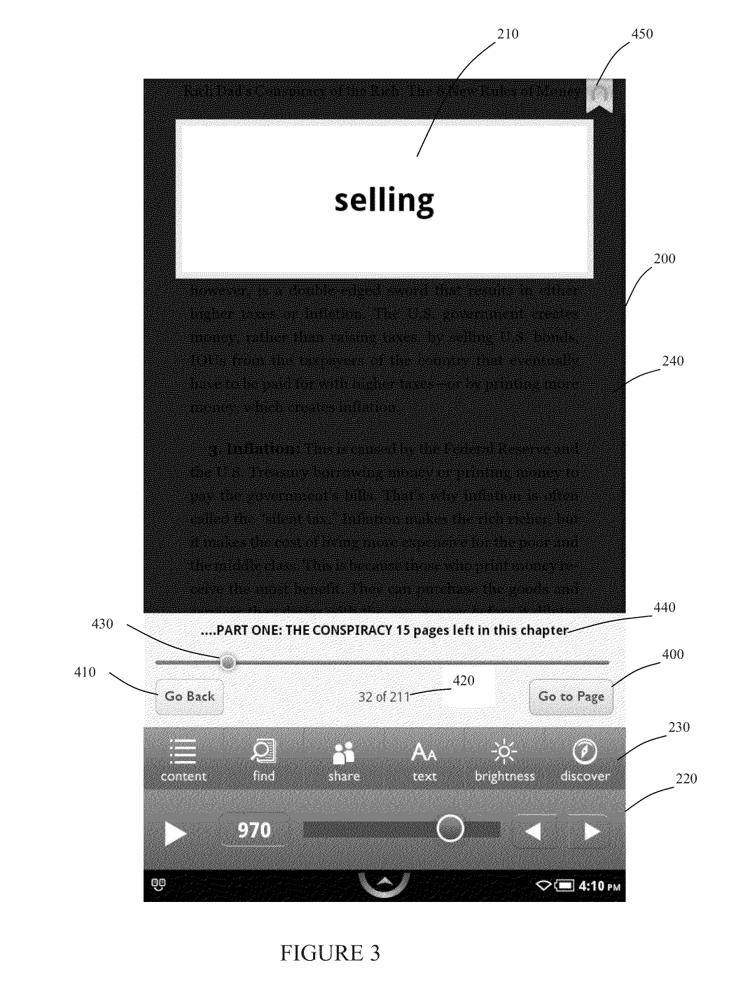

As shown in FIG. 2, at the bottom of the screen of device 200 is a control area 220. This control area 200 has several controls related to the RSVP features. Box 330 displays the current wpm rate. In the example illustrated in FIG. 2, the wpm rate is 970 wpm. The wpm rate can be adjusted either by the slide bar 320 or by the buttons 300 and 310. Button 340 is “Play” button for starting the RSVP when it has been paused. Button 350 is used to toggle between a regular reading mode and the speed reading mode of the present invention. Button 360 brings up a settings menu (230 in FIG. 3) which contains settings and functions that are conventional on device 200.

An advantage of the present invention is that it can extend battery life of the electronic device 200. By turning off a significant number of pixels on the display of device 200 using RSVP mode, normal battery life can be extended, e.g., by at least 30 minutes on present-day devices and battery systems. Darkening the display (other standard text) also helps prevent distraction when speed-reading, but the present invention can retain a display of GUI controls 220, 230 at the bottom of the screen (near hands), far enough away from word presentation view 210. In an alternative embodiment, the present invention also can turn more pixels off (black) by removing the white RSVP area 210 and turning the text white to provide the required contrast between the presented words and the darkened background.

In a further aspect of the invention, the system and method determines and displays to the user a predicted time of book completion. Since the system knows the rate at which the user is reading and the number of words remaining in the book, the system can provide an accurate time-to-completion prediction, assuming the user doesn't pause the presentation. For example, the system an display a message such as “We estimate finishing the book in 3 hrs 20 mins or at 7:18 pm.” If a user's goal is to read a book as quickly as possible, a prediction can give the user more incentive to gradually increase speed-reading rates. This feature provides a game-like quality that can ideally benefit the user, i.e., more content consumed more efficiently.

As described above, FIGS. 2 and 3 show one possible display with a white RSVP presentation box 210 at the top and controls 220, 230 at the bottom. The darkened or black central area hides the traditional presentation of the text 240 of the electronic publication, e.g., book, beneath. As described above, some traditional navigational methods persist into the speed reading mode. For example, as illustrated in FIG. 3, a bookmark tag 450 can be displayed in the upper right corner of the screen, Further navigational controls 400-440 can be displayed on the screen of the device. Button 400 allows the user to skip to a specific page number. Element 420 indicates to the user the page she is on, and the total number of pages in the electronic publication. Activation of button 410 brings the user back to the page she was on prior to any navigational jump she performed.

Element 430 is a page scrubber that allows the user to slide the button to move to other positions in the electronic publication. The user can also swipe left and right on the darkened/black page 240 to move forward or back a page, and the RSVP presentation of the present invention begins with the first sentence on that new page. When the user makes such a swipe, a transition indicator appears as they normally would to let the user know they have moved forward or backward a sentence, and as confirmation of their swipe. Also, at the user's preference option, this and other transitions can be accompanied by a sound element. Element 440 provides the user with the title of the current section (e.g., chapter) of the electronic publication and the number of pages remaining in the chapter.

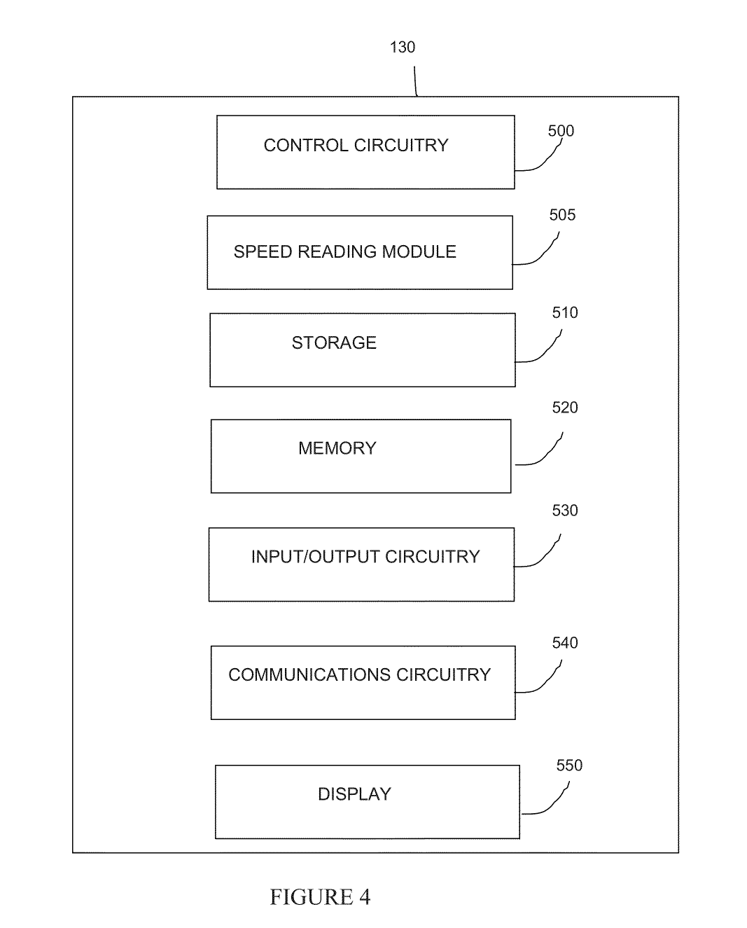

FIG. 4 illustrates exemplary device 200. As appreciated by those skilled the art, the device 200, can take many forms capable of operating the present invention. In a preferred embodiment the device 200 is a mobile electronic device. Device 200 can include control circuitry 500, storage 510, memory 520, input/output (“I/O”) circuitry 530, communications circuitry 540, and display 550. In some embodiments, one or more of the components of device 200 can be combined or omitted, e.g., storage 510 and memory 520 nay he combined. As appreciated by those skilled in the art, device 200 can include other components not combined or included in those shown in this Figure, e.g., a power supply such as a battery, an input mechanism, etc.

Device 200 can include any suitable type of electronic device. For example, electronic device 200 can include a portable electronic device that the user may hold in his or her hand, such as a digital media player, a personal e-mail device, a personal data assistant (“PDA”), a cellular telephone, a handheld gaming device, a tablet device or an eBook reader. As another example, device 200 can include a larger portable electronic device, such as a laptop computer. The invention can also operate on a desktop computer, and can be run through a web application.

Control circuitry 500 can include any processing circuitry or processor operative to control the operations and performance of e device 200. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Speed Reading Module 505 includes the hardware and software required to perform the speeding reading operations described herein.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 200, firmware, user preference information data, e.g., content preferences, authentication information, libraries of data associated with authorized users, transaction information data, e.g., information such as credit card information, wireless connection information data, e.g., information that can enable electronic device 200 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments. I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 200. Although I/O circuitry 530 is illustrated in this Figure as a single component of electronic device 200, several instances of I/O circuitry 530 can be included in electronic device 200.

Device 200 can include any suitable interface or component for allowing a user to provide inputs to I/O circuitry 530. For example, device 200 can include any suitable input mechanism, such as a button, keypad, dial, a click wheel, or a touch screen, e.g., display 550. In some embodiments, electronic device 200 can include a capacitive sensing mechanism, or a multi-touch capacitive sensing mechanism.

In some embodiments, electronic device 200 can include specialized output circuitry associated with output devices such as, for example, one or more audio outputs. The audio output can include one or more speakers, e.g., mono or stereo speakers, built into device 200, or an audio component that is remotely coupled to electronic device 200, e.g., a headset, headphones or earbuds that can be coupled to device 200 with a wire or wirelessly.

Display 550 includes the display and display circuitry for providing a display visible to the user. For example, the display circuitry can include a screen, e.g., an LCD screen that is incorporated in device 200, In some embodiments, the display circuitry can include a coder/decoder (Codec) to convert digital media data into analog signals. For example, the display circuitry or other appropriate circuitry within electronic device can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 200, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from the electronic device 200 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 200 can include one more instances of communications circuitry 540 for simultaneously performing several communications operations using different communications networks, although only one is shown in this Figure to avoid overcomplicating the drawing. For example, electronic device 200 can include a first instance of communications circuitry 540 for communicating over a cellular network, and a second instance of communications circuitry 540 for communicating over or using Bluetooth. In some embodiments, the same instance of communications circuitry 540 can be operative to provide for communications over several communications networks.

In some embodiments, device 200, can be coupled to a host device such as a cloud for data transfers, synching the communications device, software or firmware updates, providing performance information to a remote source, e.g., providing riding characteristics to a remote server, or performing any other suitable operation that can require electronic device 200 to be coupled to a host device. Several electronic devices 200 can be coupled to a single host device using the host device as a server. Alternatively or additionally, electronic device 200 can be coupled to several host devices, e.g., for each of the plurality of the host devices to serve as a backup for data stored in device 200.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for controlling display of content on an electronic device, the method comprising:
displaying a portion of content on a display screen of the electronic device, the content including text;
displaying a word presentation area on the display screen;
sequentially displaying words from the text in the word presentation area, the words being displayed at a first predetermined rate;
momentarily pausing the sequential display of words at paragraph transitions in the text;
momentarily pausing the sequential display of words at section transitions in the text; and
resuming the sequential display of words at the first predetermined rate after any momentary pause.

2. The method of claim 1, wherein the content is an electronic book and the section transitions are chapter transitions.

3. The method of claim 1, further comprising:
determining a length of a specific word to be displayed; and
displaying the specific word in the word presentation area at a second predetermined rate if the length of the word exceeds a predetermined length, wherein the second predetermined rate is less than the first predetermined rate.

4. The method of claim 3, wherein the second predetermined rate is proportional to the length of the specific word.

5. The method of claim 3, wherein the first predetermined rate is approximately 200 ms/word, wherein the predetermined length is 6 characters and the second predetermined rate is approximately 225 ms/word.

6. The method of claim 1, further comprising:
displaying a group of words simultaneously in the word presentation area, wherein the group of words have an atomic meaning.

7. The method of claim 1, further comprising:
shading the displayed portion of content on the display screen of the electronic device;
pausing the sequential display of words; and
removing the shading of the displayed portion of content.

8. The method of claim 7, further comprising:
highlighting a specific word in the displayed portion of content after removing the shading, wherein the highlighted specific word is the last word displayed in the word presentation area.

9. The method of claim 1, further comprising:
using a current location in the content and the first predetermined rate to determine an estimated time to complete the sequential display of words for the content.

10. The method of claim 1, further comprising:
displaying an image icon if there is an image contained in the displayed portion of content and pausing the sequential display of words if the image icon is selected;
detecting a swipe on a touch screen of the electronic device, and causing a change in a user's reading position in response to the detected swipe;
changing the rate of the sequential display of words in 10 words per minute increments in response to the activation of a control on the electronic device;
activating an audio element during at least one transition in the text; and
displaying a visual indicator during the at least one transition in the text.

11. A system for controlling display of content on an electronic device, the system comprising:
a display screen on which content is displayed;
a memory that includes the content and instructions for operating the electronic device; and
control circuitry coupled to the memory and coupled to the display screen, the control circuitry capable of executing the instructions and is operable to at least:
display a portion of content on a display screen of the electronic device, the content including text;
display a word presentation area on the display screen;
sequentially display words from the text in the word presentation area, the words being displayed at a first predetermined rate;
momentarily pause the sequential display of words at paragraph transitions in the text;
momentarily pause the sequential display of words at section transitions in the text; and
resume the sequential display of words at the first predetermined rate after any momentary pause.

12. The system of claim 11, wherein the content is an electronic book and the section transitions are chapter transitions.

13. The system of claim 11, wherein the control circuitry executing the instructions is further operable to at least:
determine a length of a specific word to be displayed; and
display the specific word in the word presentation area at a second predetermined rate if the length of the word exceeds a predetermined length, wherein the second predetermined rate is less than the first predetermined rate.

14. The system of claim 13, wherein the second predetermined rate is proportional to the length of the specific word.

15. The system of claim 13, wherein the first predetermined rate is approximately 200 ms/word, wherein the predetermined length is 6 characters and the second predetermined rate is approximately 225 ms/word.

16. The system of claim 11, wherein the control circuitry executing the instructions is further operable to at least:
display a group of words simultaneously in the word presentation area, wherein the group of words have an atomic meaning.

17. The system of claim 11, wherein the control circuitry executing the instructions is further operable to at least:
shade the displayed portion of content on the display screen of the electronic device;
pause the sequential display of words; and
remove the shading of the displayed portion of content.

18. The system of claim 11, wherein the control circuitry executing the instructions is further operable to at least:
detect a swipe on a touch surface of the display screen, and cause a change in a user's reading position in response to the detected swipe;
change the rate of the sequential display of words in 10 words per minute increments response to the activation of a control on the touch surface;
activate an audio element during at least one transition in the text; and
display a visual indicator during the at least one transition in the text.

19. A non-transitory computer-readable medium comprising a plurality of instructions that, when executed by at least one electronic device, at least cause the at least one electronic device to:
display a portion of content on a display screen of the electronic device, the content including text;
display a word presentation area on the display screen;
sequentially display words from the text in the word presentation area, the words being displayed at a first predetermined rate;
momentarily pause the sequential display of words at paragraph transitions in the text;
momentarily pause the sequential display of words at section transitions in the text; and
resume the sequential display of words at the first predetermined rate after any momentary pause.

20. The non-transitory computer-readable medium of claim 19, wherein the instructions further cause the at least one electronic device to:
determine a length of a specific word to be displayed; and
display the specific word in the word presentation area at a second predetermined rate if the length of the word exceeds a predetermined length, wherein the second predetermined rate is less than the first predetermined rate.

21. The non-transitory computer-readable medium of claim 20, wherein the first predetermined rate is approximately 200 ms/word, wherein the predetermined length is 6 characters and the second predetermined rate is approximately 225 ms/word.

22. The non-transitory computer-readable medium of claim 19, wherein the instructions further cause the at least one electronic device to:
display a group of words simultaneously in the word presentation area, wherein the group of words have an atomic meaning.

23. The non-transitory computer-readable medium of claim 19, wherein the instructions further cause the at least one electronic device to:
detect a swipe on a touch screen of the electronic device, and cause a change in a user's reading position in response to the detected swipe;
change the rate of the sequential display of words in 10 words per minute increments response to the activation of a control on the display;
activate an audio element during at least one transition in the text; and
display a visual indicator during the at least one transition in the text.
